(19) United States
(12) Patent Application Publication
(10) Pub. No.: US 2008/0167930 A1
(43) Pub. Date: Jul. 10, 2008

(54) METHOD AND STRUCTURE FOR END-TO-END WORKFORCE MANAGEMENT

(76) Inventors: Heng Cao, Yorktown Heights, NY (US); John Matthew Collins, West Hartford, CT (US); Daniel Patrick Connors, Pleasant Valley, NY (US); Donna L. Gresh, Cortlandt Manor, NY (US); Meng-Chen Hsieh, Elmhurst, NY (US); Jianying Hu, Bronx, NY (US); Mark A. Eaton, Ridgewood, NJ (US); Ta-Hsin Li, Danbury, CT (US); Yingdong Lu, Yorktown Heights, NY (US); Aleksandra Majsilovic, New York, NY (US); Ana Radovanovic, New York, NY (US); Bonnie K. Ray, Nyack, NY (US); Mark S. Squillante, Pound Ridge, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/621,947

(22) Filed: Jan. 10, 2007

(51) Int. Cl. G05B 19/418

(52) U.S. Cl. 705/8

(57) ABSTRACT

A workforce management tool includes an input section that receives data from one or more data sources that together reflect data of substantially an entirety of a workforce of an organization. A plurality of service modules receive and process the data in accordance with requirements of different segments of the organization. The plurality of service modules are interconnected so that a user in a segment of the organization can selectively view any data of the workforce tool that is related to that segment.

### CROSS-REFERENCE TO RELATED APPLICATIONS

The present application is related to the following co-pending applications:

U.S. patent application Ser. No. 11/______, filed on ______, to Cao et al., entitled “Method and Structure for Generic Architecture for Integrated End-to-End Workforce Management”, having IBM Docket YOR920060546US1; and

U.S. patent application Ser. No. 11/375,001, filed on Mar. 15, 2006, to Lu et al., entitled “Method and Structure for Risk-Based Workforce Management and Planning”, having IBM Docket YOR920050557US1,

both assigned to the present assignee, and both incorporated herein by reference.

### BACKGROUND OF THE INVENTION

1. Field of the Invention

The present invention generally relates to workforce management. More specifically, an integrated end-to-end workforce management method and tool spans the entire workforce cycle of an organization, including optimization capabilities in some exemplary embodiments.

2. Description of the Related Art

It has been said repeatedly that business success in the 21st century will be based on the caliber of the workforce, a workforce that is global, diverse and constantly changing in terms of skill distribution, work experience, geography, etc. Because of these factors, managing the workforce is becoming increasingly complex.

For example, the assignee of the present application has close to 350,000 employees. This workforce is global and is constantly changing in age, skills, and geographies. The management of this workforce clearly affects customer responsiveness, the ability to deliver goods and services, and the assignee's bottom line.

It is noted that 50% of the U.S. government workforce will be eligible to retire in the next 5-7 years. Additionally, more than 450 CEOs surveyed worldwide indicated growth as being their top strategic priority for the next 2-3 years. Their biggest human challenge is the lack of skills of their employees and the shortage of qualified workers.

Thus, the issue of workforce management is becoming one of the most important factors in any company's ability to deliver projects, grow revenue, and be more profitable. Therefore, companies today face the challenge of understanding how to optimize their workforce to yield the greatest business value, and forward-thinking businesses are investing in workforce optimization methodologies and solutions as a major competitive differentiator. Today, having inadequately staffed projects can be even more costly than having surplus inventory or empty shelves.

Therefore, companies today face the challenge of understanding how to optimize their workforce to yield the greatest business value, and forward-thinking businesses are investing in workforce optimization methodologies and solutions as a major competitive differentiator. Today there are numerous solutions, software systems, and services that are designed to support or fully automate some components of the workforce management cycle. Examples include systems for demand forecasting, scheduling tools, planning tools, etc.

Yet, although the true value of workforce optimization lays in the ability to support (and even automate) the entire workforce management cycle within an organization, there are no such integrated full-fledge solutions, primarily due to the lack of a flexible structure and methodology that would allow the implementation of different workforce management components and tools within one.

Thus, a need exists for a method that provides end-to-end integrated workforce management and a tool that assists in implementing such workforce management.

### SUMMARY OF THE INVENTION

In view of the foregoing, and other, exemplary problems, drawbacks, and disadvantages of the conventional systems, it is an exemplary feature of the present invention to provide a structure (and method) for workforce management of an organization wherein a user selectively has access to all data related to the functions of the segment of the organization of that user.

It is another feature of the present invention to describe an exemplary specific workforce management tool and technique that can be used in conjunction with the generic framework described in the first above described co-pending application.

It is another exemplary feature of the present invention to provide a structure and method for a workforce management tool and technique that would be usable in workforce management environments other than the generic framework described in the first co-pending application, as long as workforce data is available for or can be provided as input data.

It is another exemplary feature of the present invention to provide a method and structure so that a workforce management user can make decisions that optimize the user's local perspective and objectives of the workforce while being consistent with the global objectives of the workforce.

To achieve the above exemplary features, in a first exemplary aspect of the present invention, described herein is a workforce management tool including: an input section that receives data from one or more data sources that together reflect data of substantially an entirety of a workforce of an organization; and a plurality of service modules that receive and process the data in accordance with requirements of different segments of the organization, wherein the plurality of service modules interconnected so that a user in a segment of the organization can selectively view any data of the workforce tool that is related to that segment.

In a second exemplary aspect of the present invention, also described herein is a method of operating an organization, including providing a workforce management tool comprising an input section that receives data from one or more data sources that together reflect data of substantially an entirety of a workforce of the organization and a plurality of service modules that receive and process the data in accordance with requirements of different segments of the organization, the plurality of service modules interconnected such that a user in a segment of the organization can selectively access all data in the one or more data sources that is related to that segment; and obtaining information from the workforce management tool.

In a third exemplary aspect of the present invention, also described herein is a method of developing an end-to-end workforce management scheme in an organization, including: determining processes of the organization; determining data sources related to the processes, the data sources providing data for substantially an entirety of a workforce of the organization; and designing and implementing one or more service modules to receive data from the data sources to allow a user in one of the processes to selectively access all data related to that process.

The integrated solution of the present invention, spanning the entire workforce cycle of an organization, provides a number of benefits, including:

1) Compressed planning cycle time, including the ability to react to sudden changes in demand or supply.

2) Improved accuracy of staffing decisions and more accurate resource analysis, including uniform, standard and up-to-date views of the workforce. Workforce tools can be managed globally.

3) Minimized risk of engagement loss, and better utilization, including optimized management of resources to opportunities. Training decisions can be linked to forecasted shortages. People can be optimally matched to opportunities.

4) Clearer picture of customer patterns.

5) Linkage between demand inputs, staffing recommendations, and business performance.

6) Informed staffing strategy through continuous analysis of staffing patterns and performance.

7) Visibility into the workforce management process for all stakeholders and decision makers.

8) Better forecasting, including analytic projections of workforce trends and accurate projections of pipelines (short, mid and long-term).

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 shows in diagrammatic format a number of exemplary challenges 100 presented by the task of workforce management;

FIG. 2 shows exemplarily the fully integrated end-to-end workforce management concept 200 of the present invention, wherein key stakeholders in the workforce cycle for a company (or a business unit) such as a company that provides information technology (IT) infrastructure services, are identified, along with their respective tasks;

FIG. 3 shows in flowchart format 300 the steps underlying the concepts described in FIG. 2;

FIG. 4 shows an exemplary end-to-end workforce management structure and methodology 400;

FIG. 5 shows an exemplary structure and methodology that embodies the integrated concepts of the present invention;

FIG. 6 shows one exemplary embodiment of the aspect of data integration 500 in the method of the present invention;

FIGS. 7-15 show details related to the demand forecasting component of an exemplary embodiment of the present invention;

FIGS. 16-23 show details related to the capacity planning component of an exemplary embodiment of the present invention;

FIGS. 24 and 25 are directed to an exemplary multi-skill assignment and gap/glut optimization aspect of the present invention;

FIGS. 26 and 27 are directed to the resource assignment aspect of the present invention;

FIGS. 28 and 29 are directed to the aspect of the present invention supporting the available to sell/promise component;

FIG. 30 exemplarily shows additional capabilities and interfaces 3000 available for high-level planning and executive information;

FIGS. 31-33 exemplarily show risk-based stochastic optimization, as applied to price-driven demand and engagement selection components of the present invention;

FIG. 34 illustrates an exemplary hardware/information handling system 3400 for incorporating the present invention therein; and

FIG. 35 illustrates a signal-bearing medium 3500 (e.g., storage medium) for storing steps of a program of a method according to the present invention.

### DETAILED DESCRIPTION OF AN EXEMPLARY EMBODIMENT OF THE INVENTION

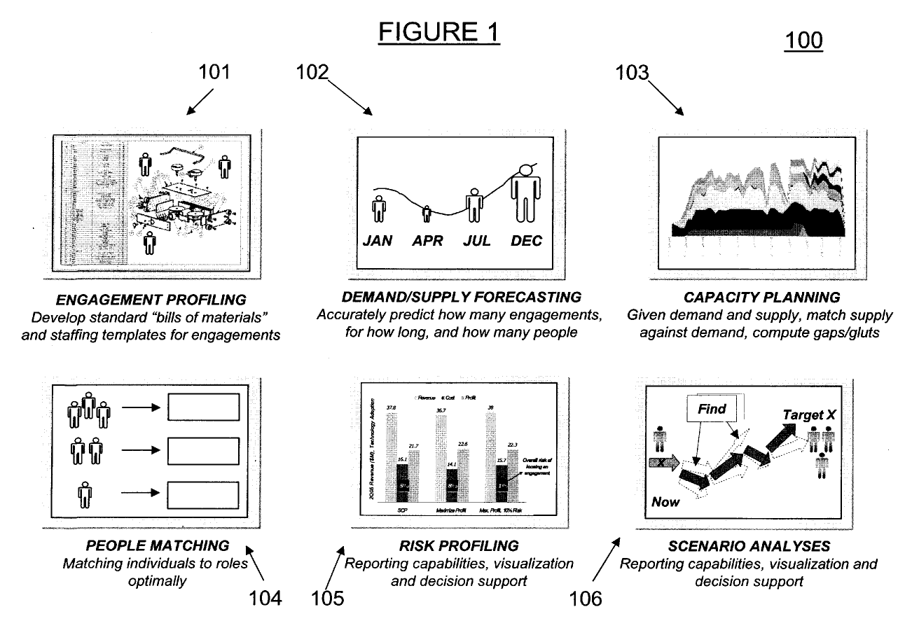

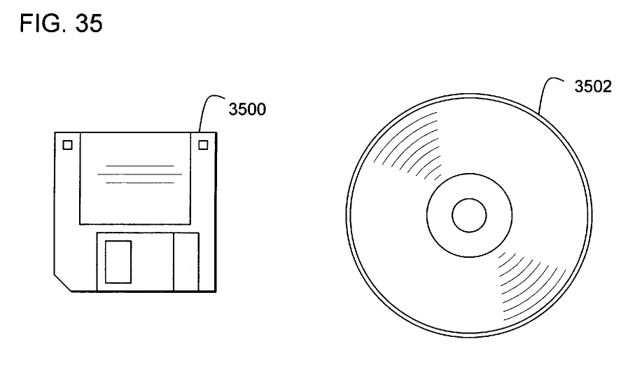

Referring now to the drawings, and more particularly to FIGS. 1-35, exemplary embodiments of the present invention will now be described.

When one looks into area of workforce management there are many issues one can work on. FIG. 1 shows diagrammatically a number of these challenges 100.

Engagement profiling (101): If one were to take the supply chain approach in managing a workforce, one of the first things one would need to develop is a methodology to construct “bills of materials” for engagements. For example, one can apply advanced clustering and statistical analysis techniques to the historical data on projects, in order to find common patterns in terms of their skill and job role mix, and create a standardized taxonomy for projects on the basis of their resource requirements.

Demand/Supply forecasting (102): One of the key issues in workforce management is the ability to accurately forecast the demand for resources (how many projects are expected, for how long, with how many people) and the supply of resources (attrition, people making changes in their skills).

Capacity planning (103): Based on the demand forecast and a bill of materials for projects/engagements, one can look ahead (either on a short term or a long-term horizon) and predict future excesses and shortages (i.e. “gaps” and “gluts”) in the workforce, and provide hiring, firing, training, re-skilling recommendations. One can also use advanced optimization techniques to account for uncertainty in demand and to compute optimal capacity plans that maximize some business objective (e.g. profit). The second of the above-identified co-pending applications discusses a tool directed to this aspect of workforce management.

Matching people to projects (104): Given immediate needs for staffing the projects, one needs to be able to match individuals to roles in “optimal fashion”, taking into account specific preferences and business rules (such as skill combination, travel, availability, geographical location, etc). One example is a tool that uses existing constraint satisfaction technology to fill the “open seats”, or to replace positions occupied by contractors with regular employees.

Risk profiling (105): One can use advanced probabilistic models to allow for support in decision making. For example, for selected staffing levels, one can compute the overall risk of revenue loss, revenue loss for individual project types, or compute the staffing levels that correspond to the selected risk preferences. Furthermore, one can also use advanced optimization techniques to account for uncertainty in demand, to compute optimal capacity plans that maximize some business objective (e.g., profit), and to incorporate risks in such optimizations.

Scenario Analyses (106): Advanced reporting capabilities and visualization to provide visibility into the workforce decision to all stakeholders (people who do planning, delivery, sales, executives, etc.). Examples include revenue realization/trends in the solution portfolio, relationship between planned and realized revenue by sector/solution, relationship between planned and actual staffing, correlation between staffing and project quality, and various analytical capabilities to support decision making.

Often described as “the right person in the right place at the right time at the right price”, an “ideal” workforce optimization solution will combine managerial discipline with advanced analytics and information technology (IT). Such solutions would be able to produce everything from the forecast of the future demand for resources and the future supply of resources, skills taxonomies, “perfectly staffed” and timely delivered projects, and efficiently deployed workers, to the interlocked sales, planning and delivery organizations—all enabled by an integrated, secure, global network.

However, despite the proliferation of workforce analytics, such full-fledge solutions are still rare. Most existing solutions focus on one aspect of the workforce optimization, or one business process within the workforce lifecycle, e.g. demand forecasting, scheduling, etc. Such solutions are designed to locally “optimize” selected business process, thus being “myopic” with respect to optimizing a global business objective of the organization.

In order to have an effective integrated workforce management, there is a need for a set of designs and methods that will optimize both the local business process of each stakeholder and the global business objective of the entity.

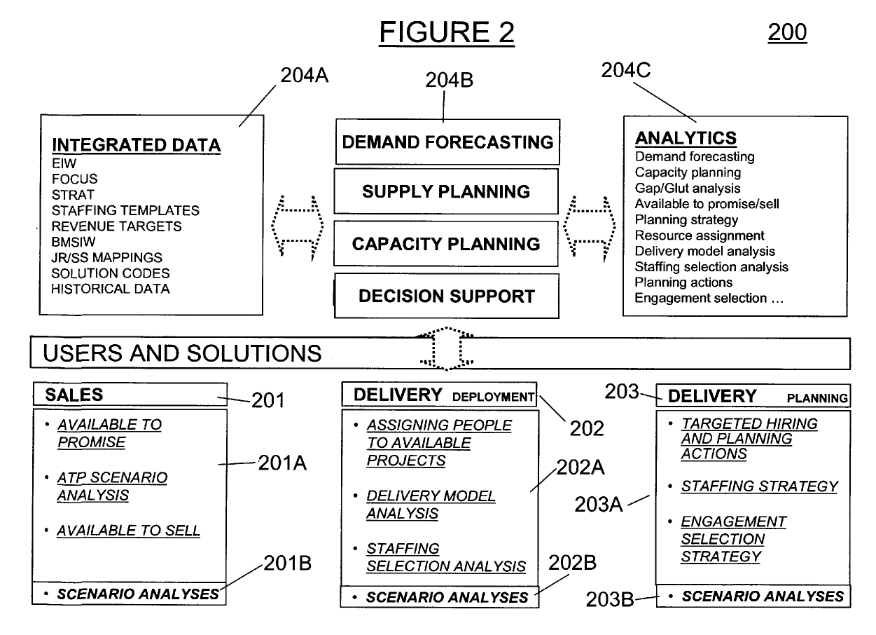

The integrated concept of the present invention, shown in overview in FIG. 2, describes a methodology and computer-implemented tool for integrated end-to-end workforce management. Workforce optimization and management is not only about the local management of business processes within the workforce cycle—it requires an integrated approach that will enable a true workforce management lifecycle.

In the context of the present invention, the term “entire workforce management cycle” refers to all aspects of managing the workforce of a business entity which is performed over an interval of time based on the type of business, the seasonalities of the business, the dynamics of the business, the processes and steps involved in managing the workforce of the business, and so on. The present invention focuses on the entire workforce management cycle of a business entity, which is repeated from one cycle to the next and includes feedback from previous cycles in the management of the current cycle. The term “end-to-end integrated workforce management” refers to the integration of all aspects of workforce management over the entire workforce management cycle as well as all connections and interactions among workforce management cycles.

The present invention recognizes that workforce management typically involves many stakeholders (i.e., sales, delivery, planning, finance, deployment, development, human resources, etc.), each with their own local perspectives and objectives, which are often conflicting or myopic. Therefore, for each organization, in order to have an effective workforce management, there is a need to first identify these key stakeholders and the connections among them.

Thus, the first part of the present invention calls for a) identifying elements of a business entity, their structural organization and interconnection topology, and b) combining them into an integrated end-to-end workforce cycle. Let us use as an example a company (or a business unit) that provides information technology (IT) infrastructure services.

For such a company, as shown exemplarily in FIG. 2, the solution 200 includes the identification of the key stakeholders in the workforce cycle, such as: sales 201 (teams who sell solutions and reach to clients), development 202 (teams who develop solution and architect new technologies), planning 202 (teams who decide how the existing projects will be staffed and delivered, both in short-term and long-term horizons), delivery 203 (teams who assign resources to projects and deliver the project to customers), HR (who decide and implement hiring, re-skilling, and other resource actions and policies), strategy (teams who decide on longer-term business objectives), finance (who implement metrics and measurements to evaluate the success of the organization).

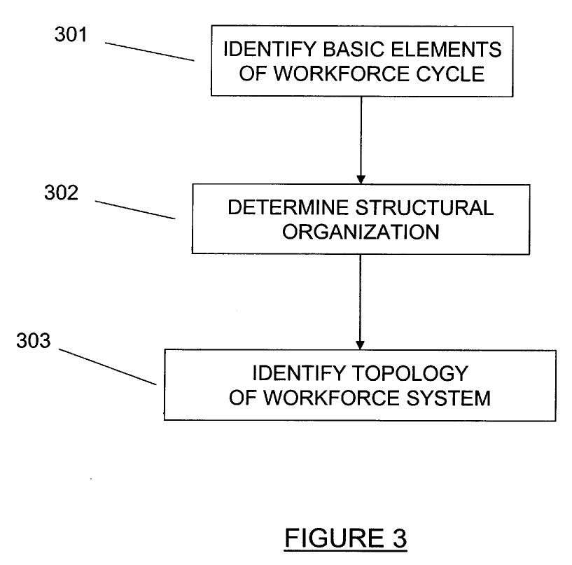

Once these basic elements of the workforce cycle have been identified, the next step is to determine their structural organization. FIG. 3 shows a flowchart 300 of these steps, including the initial step 301 of identifying the basic elements of the workforce cycle and determining their structural organization in step 302.

In other words, in step 302, processes are identified that define these elements. For example, planning 203 (in FIG. 2) consists of numerous processes that include, for example, forecasting the demand for projects and resources, computing optimal capacity plans to satisfy projected demand, analyzing the gaps and gluts in each skill, constructing and analyzing project templates, etc. Similarly, sales element 201 includes processes such as available to promise/sell, demand conditioning, promotions, etc.

Finally, the third step 303 in this methodology includes identifying the topology of the workforce system, i.e., identifying the relationships between these elements. For example, in a sub-optimal environment, sales teams 301 can sell and promote projects without knowing how many people there are currently available for staffing, which projects would make best use of available resources, which project should (or should not) be sold given the current state of the workforce, what are the trade-offs between the price/duration/delivery time, which solutions will not be supported anymore, which solutions are affecting profitability of the organization, etc. Therefore, in an “optimized” environment, this calls for the relationships between e.g. sales and planning, sales and delivery, and sales and development.

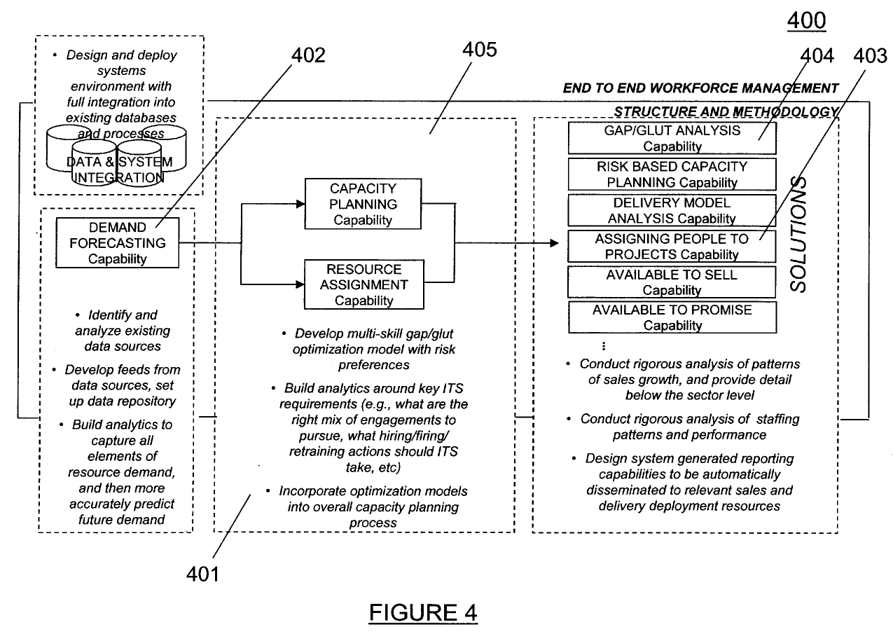

Thus, as shown in FIGS. 3 and 4, following the identification of the overall workforce topology, the present invention provides a methodology and tool for integrated end-to-end workforce management comprising: designing, managing and optimizing each element in that overall topology, their structural organization and interconnection topology designed to maximize both the local objective of each element and the global business objective of the entity over a planning cycle.

One exemplary embodiment, therefore, returning now to the presentation of FIG. 2, might include:

1) developing and implementing methods for demand/supply forecasting and capacity planning for users in planning;

2) developing/implementing methods for resource matching for users in delivery;

3) developing/implementing methods such as available to sell/promise to enable users in sales;

4) developing scenario analysis and decision support for higher-level planning;

5) developing reporting capabilities and system alerts that will connect all parties; and, finally,

6) integrating/optimizing all to meet the global business objective.

FIG. 2 shows these interrelationships, wherein integrated workforce data 204A is provided into various component modules 204B to permit various analytics 204C to be executed. In the user side shown in the lower sections, the various workforce users 201, 202, 203 will each have their respective functions 201A, 202A, 203A, including capability for scenario analysis 201B, 202B, 203B. Some examples of analytics and scenario analyses are discussed in more detail below.

The techniques of the present invention are somewhat related to the two above-identified co-pending applications.

Relative to the first co-pending application, the present invention is one example of a specific tool that can be implemented on the generic framework discussed therein. However, the present invention is not limited in being implemented on this generic framework, since it could be implemented in other frameworks that provide data related to an organization and workforce aspects of that organization.

Moreover, as discussed shortly, the present invention expands on the concepts of the generic framework into a tool having additional capabilities, including optimization of local components as consistent with global optimums. Thus, the present invention is distinguished from the generic framework and methodology discussed in the first co-pending application, even if there are some similarities.

The second co-pending application is one example of the risk-based method that could be incorporated as modules in an integrated workforce tool of the present invention and uses a risk-based approach that is further discussed below for various aspects of the present invention, including gap/glut analysis and aspects of optimization of various other analyses related to management of a typical organization workforce.

Examples of Analytics: Target Hiring and Planning

One important aspect of this end-to-end planning system of the present invention is its ability to provide support for the decision makers who address resource actions, such as hiring, re-skilling or training, or contracting. Issues presented to these decision makers include a determination of which skills should be targeted for hiring, based on demand, supply, gaps, engagement revenues, costs, risks of lost engagements, etc.

In this end-to-end system, the gap and glut results from various components of the planning system can be analyzed using the risk tolerances, business rules, preferences or objectives of the organization, and plans for closing the gaps and gluts through resource actions can be proposed by the imbedded decision support tools. For example, given gaps and gluts, costs, transition paths and lead times, acquisition costs and times, risk tolerances, etc., recommendations are made by the tool on how to close the gaps and reduce the gluts. More information on gap and glut analysis is discussed in the second of the above-identified co-pending applications, the contents of which are incorporated herein by reference, and which method and tool could potentially be used as a subcomponent in an integrated tool of the present invention.

Examples of Analytics: Assigning People to Projects

Assigning people to projects or opportunities can be a complex task if the problem scope is large, the visibility to the data is limited or if decision support tools are not provided. This end-to-end system addresses these issues by integrating and making accessible the global data and by imbedding robust decision support tools that can solve large scale assignment problems. Given the available projects and resources, and desired business rules for the matching, the decision support tools can find good, feasible assignments.

To answer the question of which available resource would be best to fill an open slot, the present invention exploits various methods of mathematical programming. That is, given a description of demands (e.g., skills, time required), a description of supply (skills, availability, and other attributes such as bench time, etc.), and a set of rules, find a feasible match of people to projects. A combination of advanced probabilistic methods and advanced nonlinear (but including linear as a special case) optimization techniques are used to determine the optimal assignment of people to projects.

Possible alternatives include stochastic loss networks, stochastic queuing networks, stochastic programming models, stochastic dynamic programming models, deterministic dynamic programming models, stochastic optimal control models, deterministic optimal control models and stochastic programming. However, the present invention is not limited to these alternatives and can incorporate any probabilistic and optimization models relevant to optimal assignment.

Examples of Analytics: Delivery Model Analysis

Moreover, as a delivery model analysis, given the current portfolio of engagements and resources (employees of a company and contractors) and tolerances on the risk of lost engagements, how should resources be assigned to engagements so that profit is maximized?

Thus, one complex problem addressed by the tool of the present invention is, given relevant costs for resources, revenues from engagements, risks of lost engagements, and engagement bills of materials, determine the optimal usage of resources (from a profit, revenue or cost perspective). A combination of advanced probabilistic methods and advanced nonlinear (but including linear as a special case) optimization techniques are used to determine the optimal usage of resources. The objective could be to maximize revenue or profit, or to minimize overall cost. Constraints contain mutual relationships between system parameters (project risks, arrival rates, skill capacities), as well as risk tolerances. Since resources of particular skills can be contracted (or handled by other sourcing strategies) and that yields different cost than in the case of pulling all resources from IBM pools, the result of optimization represents amounts of resources that should be contracted (or handled by other sourcing strategies) in order to achieve a desirable objective.

Possible alternatives include stochastic loss networks, stochastic queuing networks, stochastic programming models, stochastic dynamic programming models, deterministic dynamic programming models, stochastic optimal control models, deterministic optimal control models and stochastic programming. However, the present invention is not limited to these alternatives and can incorporate any probabilistic and optimization models relevant to delivery model.

Examples of Analytics: Staffing Selection Analysis

As an example of staffing selection analysis, when making decisions about which resources to use, issues such as the availability of resources who will be rolling off current projects and the uncertainty associated with this, can be important components of future available supply. This integrated end-to-end system can make that data available to the advanced decision support tools that perform staffing analysis.

Aspects of this analysis include resolving whether it would be better to assign a more expensive available resource or a less expensive resource rolling off an engagement in near-term. The present invention includes mathematical programming and advanced probabilistic methods to capture uncertainty in the availability of supply so that issues such as roll-off of existing assignments can be considered when building the planned assignments. This and related combinations of advanced probabilistic models and advanced nonlinear (but including linear as a special case) optimization techniques are used to perform such staffing analysis.

The analytic method used in addressing these issues in the present invention is a stochastic dynamic programming approach. Given the current assignments of resources to projects, the amount of available supply and the forecasts of future project offers as well as near term project completions (resource roll-offs), the set of optimal resource allocations to incoming projects is computed. Optimization in this framework could be minimizing long run cost, or maximizing long run profit, etc.

Possible alternatives to the approach exemplarily discussed below include stochastic loss networks, stochastic queuing networks, stochastic programming models, stochastic dynamic programming models, deterministic dynamic programming models, stochastic optimal control models, deterministic optimal control models and stochastic programming. However, the present invention is not limited to these alternatives and can incorporate any probabilistic and optimization models relevant to staffing selection.

Examples of Analytics: Engagement Selection Strategy

Another aspect of the end-to-end methodology considers the collected revenue through a careful engagement selection, assuming that the price per revenue is fixed. Then, subject to available skill capacities, their costs, solution templates, risk tolerances, etc., one can determine what is the proportion of each engagement/offering type that should be accepted in order to maximize revenue/profit and exactly the methods for enacting this proportion of engagement/offering selection.

That is, relative to engagement selection, the question is the mix of opportunities that should be pursued, given the resources and engagements in any business entity. Therefore, given relevant costs for resources, supply of resources, revenues from potential engagements, risks of lost engagements, and engagement bills of materials, it is to be determined which engagement opportunities should be accepted to maximize profits.

The present invention uses probabilistic methods and optimization to solve these problems under various sources of uncertainty and the inclusion of setting or constraining risk preferences. For example, for those less profitable engagements a company might decide to be even more selective, in order to reduce the chance of rejecting more profitable engagements. A combination of advanced probabilistic models and advanced nonlinear (but including linear as a special case) optimization techniques are used to determine the optimal usage of resources.

One way of maximizing revenue inflow is through a careful customer selection, and this is directly related to managing the amount of available resources. In order to reduce risk of losing more profitable engagements, a business can become more restrictive to those that are less profitable. Specific customer admission rates could be obtained from a nonlinear optimization problem.

An objective of this optimization is to maximize expected profit or revenue rate for the organization. Both the objective function and constraints that were previously described incorporate project admission decisions through variables that represent a proportion of admitted engagements. The result of this nonlinear optimization suggests a project selection policy (e.g., a thinning policy) that achieves the objective. Possible alternatives include stochastic loss networks, stochastic queuing networks, stochastic programming models, stochastic dynamic programming models, deterministic dynamic programming models, stochastic optimal control models, deterministic optimal control models and stochastic programming. However, the present invention is not limited even to these alternatives and can incorporate any probabilistic and optimization models relevant to engagement selection.

Often the strategy for deciding the appropriate mix of opportunities to pursue is not determined because of the lack of data to support the analysis and the lack of decision support tools to address the complex problem. This end-to-end system can provide the necessary data to an engagement selection strategy tool.

Examples of Analytics: Staffing Strategy

Relative to the aspect of staffing strategy, an exemplary goal is the determination of the best capacity staffing levels for each skill, again to maximize profits. A similar issue relates to the risk of losing an engagement, given the current staffing levels and given long term demand and supply outlooks and business strategies, determining sourcing strategies that align the delivery capability with the business plans, and acceptable risk preferences.

The present invention includes a risk-based approach to capacity planning in general, and a corresponding staffing strategy, in particular, that captures various sources and types of uncertainty and their interactions. These means and methods determine the risk of losing engagements of each type, given the current staffing levels for skills of each type. These means and methods also determine the best capacity staffing levels for each type of skill to maximize profits or revenues or minimize costs, given constraints on risk tolerances.

The risk-based approach of the present invention addresses tradeoffs among capacity levels, costs, revenues, profits, engagement loss and other business risks and concerns. A combination of advanced probabilistic models and advanced nonlinear (but including linear as a special case) optimization techniques are used to determine the optimal usage of resources. The analytic method applied to estimate optimal staffing levels is nonlinear optimization. The objective can be to maximize expected revenue or profit rate or to minimize expected cost. Constraints reflect the mutual relationships between system parameters, such as arrival rates of projects, project risks and available skill capacities. They also incorporate staffing templates, revenue rates, costs of used resources, risk tolerances, etc.

Possible alternatives include stochastic loss networks, stochastic queuing networks, stochastic programming models, stochastic dynamic programming models, deterministic dynamic programming models, stochastic optimal control models, deterministic optimal control models and stochastic programming. However, the present invention is not limited even to these alternatives and can incorporate any probabilistic and optimization models relevant to staffing.

Examples of Analytics: Available to Promise

Relative to issues of sales, such as available to promise, the issue is whether the salesperson can promise a deal to a customer within certain time and price limits and, for a given opportunity, what are the trade-offs between time and price.

For example, given net available resources, over time (i.e., available resources after accounting for demand for resources from committed work), and given resource needs for a potential engagement, the task is to determine the feasibility of the engagement, either at the desired time or at a different time, if allowed. If also given costs of resources, the cost of the engagement (if feasible) can also be determined using the present invention, or timing and cost of the least costly option, if timing is flexible. In order to obtain the desired results, a system is modeled as a stochastic process. That is, given the current number of engaged resources and future forecasts of project completions as well as future demands, the probability is computed that the system will be in a certain state (e.g., the probability of having enough available resources) at some point of time in the future. The parameters that play an important role in this analysis are project arrival processes, distributions of project durations, staffing templates, etc.

Thus, the integrated end-to-end system of the present invention provides advance decision support for Available to Promise (ATP) and Available to Sell (ATS) capability, using a graphical user interface (GUI) capability for running different scenarios. These advance demand management techniques require detailed knowledge of real-time supply availabilities. These critical data elements are accessible via the end-to-end system described herein.

Examples of Analytics: Available to Sell

Relative to available to sell (ATS), the sales department is presented with determining, given the current state of workforce resources, what offerings should be promoted by the sales force. That is, given net resources (e.g., resources available after committed engagements) and potential engagements, along with their bills-of-materials, the best mix of engagements to sell can be determined. This could be based either on potential revenue (if known) or, more simply, on minimizing unused resources. The optimal mixture of engagements to sell is exemplarily obtained by solving a nonlinear program. The objective is to maximize the expected revenue or profit rate, given the staffing templates of different engagements and available amount of resources of each skill type.

Exemplary Structure and Methodology of the End-to-End Workforce Management Tool

FIG. 4 shows an exemplary structure and methodology 400 of the present invention that provides a tool that is a fully integrated, scalable, and reuseable end-to-end solution to support the workforce management process. Such an embodiment includes a workforce system with scalable optimization capabilities and system structure across the complete workforce management life cycle.

At the core of the system 400 shown in FIG. 4 are analytical capabilities to:

1) automatically develop (or readjust) skills taxonomy and design bills of materials for existing engagements 401,

2) forecast demand for projects and resources 402,

3) optimally allocate individuals to opportunities, while taking into account specific preferences and business rules 403,

4) predict future “gaps” and “gluts” in workforce, given the demand for human resources and available supply 404, and

5) develop capacity plans by taking into account demand uncertainty, business objectives, and risk preferences 405.

From these core methodologies, a workforce system manager could also easily derive new capabilities, to address specific needs and connect different user segments, such as sales, planning and delivery organizations. It is noted that the exemplary embodiments discussed hereinbelow do incorporate a number of these capabilities.

For example, for the sales people, there could exist a customized view to answer questions such as: “Can I promise this deal to a customer within certain time and price limits?”, “For a given opportunity, what are the trade-offs between time and price?”, “Given current state of workforce resources, what offerings should the sales force promote”?

For the teams involved, one delivery could “match people to projects, generate recommendations for staffing individual resources to the project that are feasible, while adhering to the business rules for staffing”, “Determine the optimal usage of resources (from a profit perspective)”.

For the teams involved in planning, one would address issues such as: “What are the best capacity staffing levels for each skill to maximize profits”, “What are the risks of losing engagements, given the current staffing levels? How does the current staffing level deviate from what was expected? What hiring, retraining, firing, etc., actions should be taken for each skill based on demand, supply, gaps/gluts, revenues from engagements, and costs for skills?”

There are numerous ways of how these individual capabilities could be implemented. Examples include: 1) statistical methods and predictive modeling to compute demand and supply forecasts, 2) stochastic loss network model for general risk-based workforce management under uncertainty and a stochastic optimization framework for general risk-based capacity planning under uncertainty, including the determination of optimal planning actions, 3) linear programming to assign individual resources to existing opportunities, while respecting the business rules for staffing, 4) and the service-based workforce system structure that enables flexible solution reusability, 5) data warehousing techniques to manage and integrate different data sources, etc.

Again, as noted above, exemplary embodiments of the present invention describe the incorporation of various of these capabilities.

The implementation of the present invention should preferably be a fully integrated end-to-end solution, highly scalable, with a service oriented design that enables flexible solution reusability, and the management and integration of different data sources. All data sources (e.g. data bases containing the information on skill supply on closed projects, on ongoing projects, claims data, opportunity pipeline) should preferably be consolidated within a unified repository and to eliminate the need for manual data collection, processing, and validation. This allows for a fully automated workforce cycle.

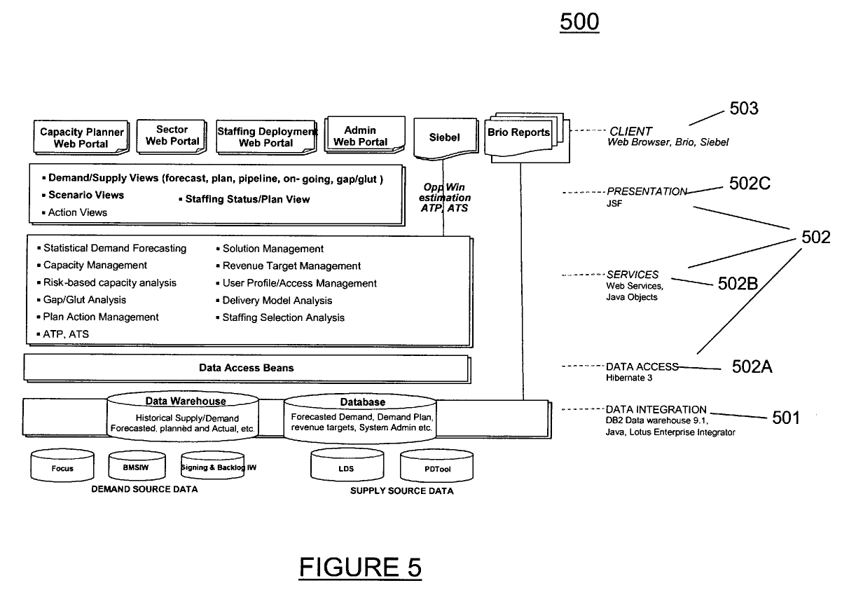

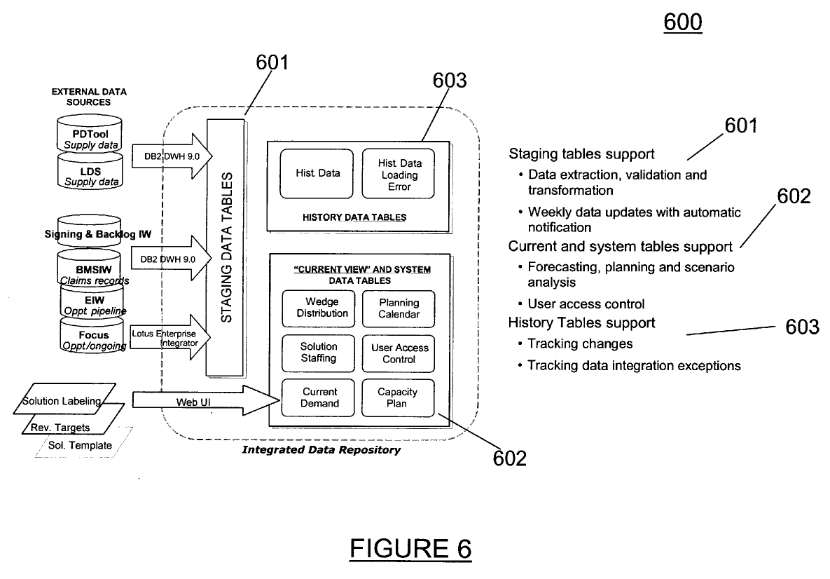

FIG. 5 shows an exemplary implementation 500 of the system integration structure and methodology 400 discussed above relative to FIG. 4. This implementation 500 provides a robust service-oriented workforce system structure that integrates advanced analytics discussed above with a unified data repository, discussed shortly relative to FIG. 6, and allows for quick and seamless integration of new solutions, capabilities, and users.

FIG. 5, therefore, presents one exemplary workforce system integration structure 500 of the present invention, and shows a tier design of the system. The bottom layer 501 is the backend tier, EIS (enterprise information system) tier, explain in more detail in FIG. 6.

The middle tier 502, in turn, also comprises three layers, including a data access layer 502A, a business domain and services layer 502B, and a presentation layer 502C. The data access layer 502A maps the relation world (relational data tables in the backend tier) to the object work (the java objects in the middle tier), which makes the entities in the middle tier 502 to be loosely coupled with the data base design. Most the work in the middle tier 502 is done in the business domain and service layer 502B where the business domain logic is implemented.

The Business Domain and Services Layer 502B is implemented in this exemplary embodiment using a Service Oriented approach. A generic wrapper is designed to quickly turn an analytical model into a service component that is able to interact with the rest of the system. On top of the business domain and services layer various modular view components 502C are designed, which can be assembled into different workbench for various user role types.

The upper tier 503 above the middle tier 502 is the client tier. With the component and service oriented design, the system presently is able to support various clients, including web browsers, MS Excel, etc., all through web services interfaces. Also the service components, such as a statistical opportunity win estimation module, an available to promise module, and an available to sell module, are able be used by other systems as well.

The Services layer 502B substantially corresponds to the core methodology in the discussion above for FIG. 4.

FIG. 6 exemplarily demonstrates the data integration 600 of the exemplary embodiment shown in FIG. 5, using data warehousing techniques to manage and integrate a large number of data sources into a unified repository, thus eliminating the need for manual data collection, processing, and validation.

This approach shown in FIG. 6 is only one possible approach for data integration within such structure and methodology as shown in FIGS. 4 and 5, to manage and integrate a large number of data sources into a unified repository, thus eliminating the need for manual data collection, processing and validation. The data integration plan of FIG. 6 has exemplarily been designed as a three-step process for data integration, as follows.

1. The first step is to compose two staging sub-steps with the stage I tables that bring data from external data sources. In fact, in the exemplary embodiment, the stage I tables have almost the exact format of their counterparts in the external data sources. The data validation/transformation is done in the stage II tables through intensive data validation, based on system defined reference tables. Only valid data past the first step will be ready to get into the “current view”, which will be used to support run time system functionalities. This two-stage design enables easy adjustment to data source changes, and ensures that the performance of the system will not be affected by errors and by time consuming data validation processes.

2. The second step is the data loading process from the staging II tables to the “current view” tables. During this step certain business rules are implemented. For example, for capacity planning, a certain revenue threshold is applied to filter out very small revenue opportunities. This type of business rules is preferably implemented in the second step in data integration layer, rather than within the other system layers, because this approach provides better performance and flexibility to changes.

3. For the third step, when new data is read from the first step and “current view” data is rolled out and loaded into the history tables. With the rich history tables, the workforce system supports tracking changes and exceptions from data integration. Also, the history data is critical for building robust analytical models and supports its validation and tuning.

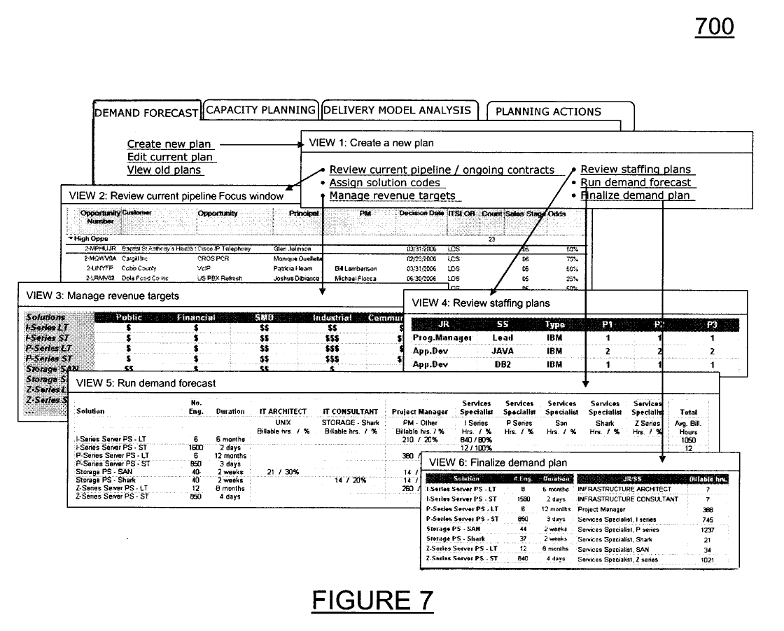

The following discussion, relative to FIGS. 7-33, describes how the exemplary structures 400, 500 of FIGS. 4 and 5 interrelate and function, thereby explaining the core methodology of the present invention, as well as the additional capabilities that include optimization capabilities.

The Demand Forecasting Component

FIGS. 7-15 relate to the demand forecasting component of the tool. FIG. 7 exemplarily shows six multiple web views 700 that support planning, delivery, interlock, analytics, and decision making throughout the entire workforce management process.

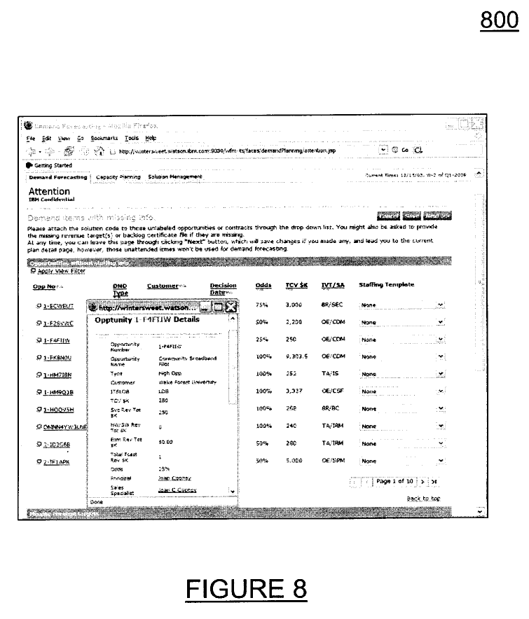

FIG. 8 shows exemplarily a demand forecasting interface 800 that allows a planner to access existing information sources, combine them in a demand forecast, and to interact with different components of the demand and to re-adjust a forecast accordingly.

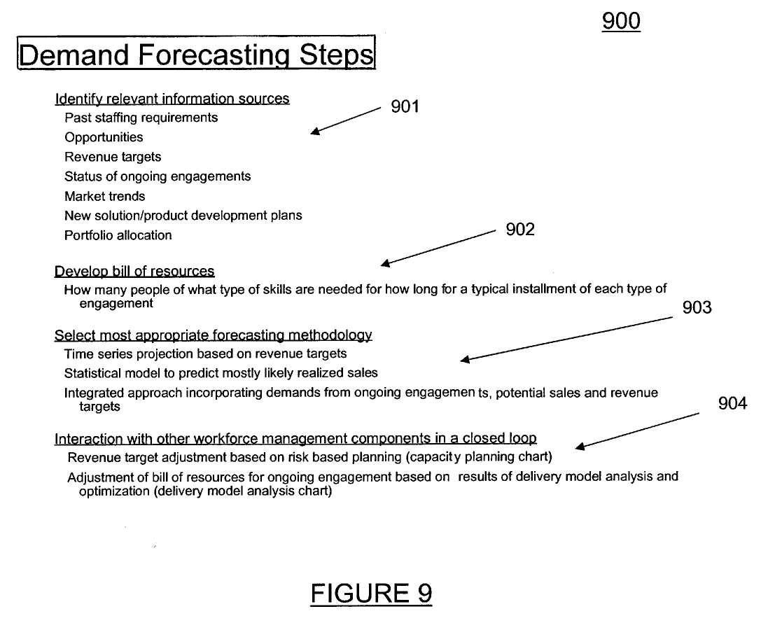

FIG. 9 demonstrates exemplarily a series of steps 900 that addresses the development of the demand forecasting component. A similar development sequence would be used for other components. The development starts in step 901 with identifying and investigating all possible sources of information regarding any factor that may affect workforce demand. Step 902 involves developing a “bill of resources”, which describes how many people (or hours of work) of what type of skills are needed for how long for each potential or ongoing engagement.

Such a bill of resources could be developed as part of a resource requirement based engagement taxonomy which groups together engagements with similar workforce requirements and identifies the typical requirement for each group, or it could be individually identified for each engagement. It could also be implemented as a combination of both. That is, it could start with the “default” bill of resources called for by the engagement taxonomy and then be customized for a particular engagement.

Once the information sources are identified, in step 903 the most appropriate forecasting methodology is selected. For example, if all information that is available in an organization is the resource requirement in the past periods, then one could use time series projection techniques to predict likely future requirements. If revenue targets are also available, then this projection can be adjusted based on the revenue targets. If the organization has very reliable and complete record of potential sales for the future period, then one can develop a statistical model to predict most likely realized sales.

Finally, based on the availability and reliability of various information sources, the preferred methodology could be one that integrates all information regarding ongoing engagements, potential sales, and revenue targets.

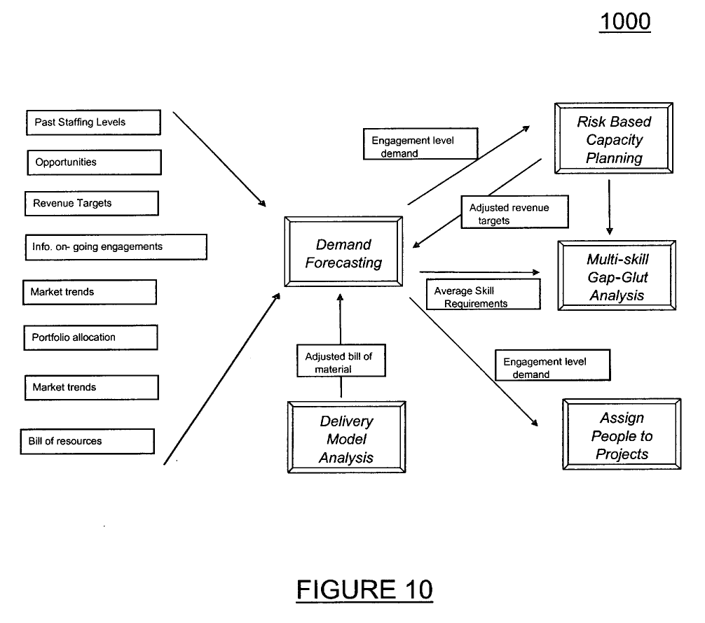

Furthermore, the design of the demand forecasting component should take into consideration its interaction with other components in the integrated workforce management system (step 904), as exemplarily demonstrated by the interactions 1000 shown in FIG. 10. For example, revenue targets, as well as what type of engagements should be pursued, may be adjusted, based on an analysis done by the risk based planning component of the tool. Thus, the recommended revenue targets as well as engagement targets output from the risk based planning component could be fed back as input to the demand forecasting components again, to adjust the workforce demand.

Also, the bill of resources for ongoing engagements may need to be adjusted, based on latest results of a delivery model analysis. For example, based on current situation, one might want to increase the use of contracted resources for an ongoing engagement, to free up employee resources for a more important upcoming engagement.

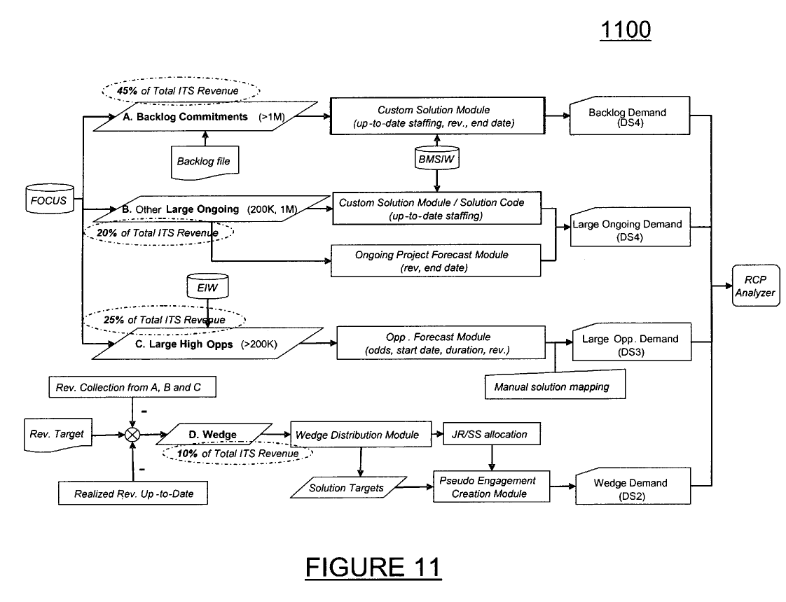

FIG. 11 exemplarily shows more details of the top-down and bottom-up forecasting methodology 1100 of this aspect of the present invention, that integrates all available data and provides statistical models to address various sources of uncertainty.

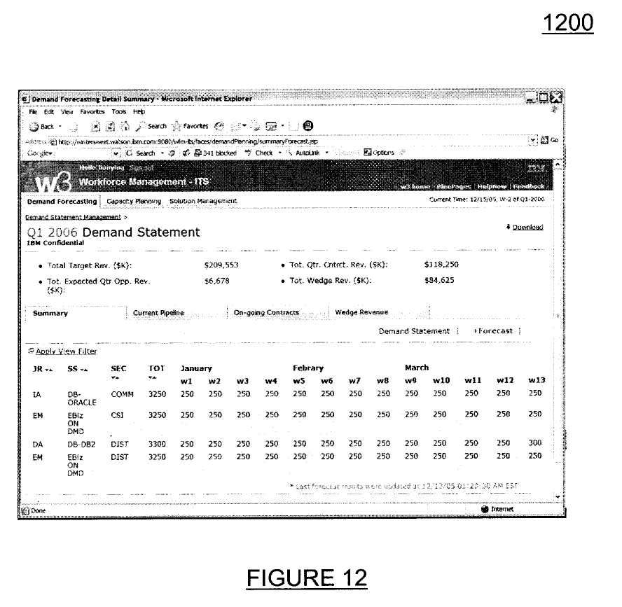

FIG. 12 shows an exemplary summary view 1200 of a demand forecast.

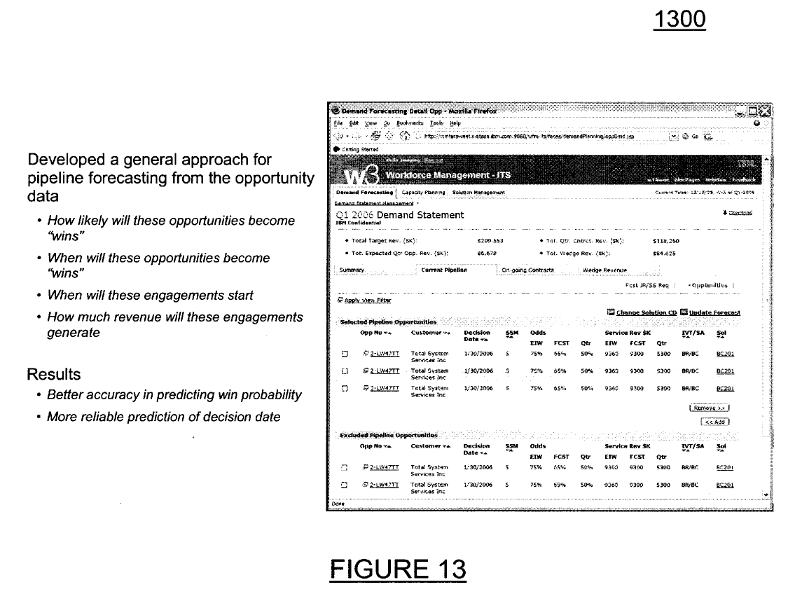

FIG. 13 exemplarily shows a view 1300 of the statistical forecasting method that is provided by the present invention to analyze the opportunity pipeline data and to predict how many of these opportunities will turn into reality.

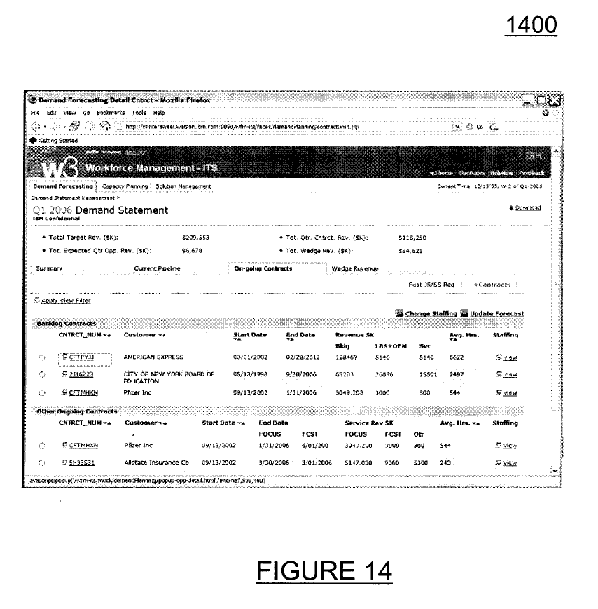

FIG. 14 exemplarily shows a view 1400 for demand statement for ongoing contracts. This view provides detailed information regarding each ongoing contract, reports on up-to-date staffing information, and supports manual adjustments of future staffing plans, based on default.

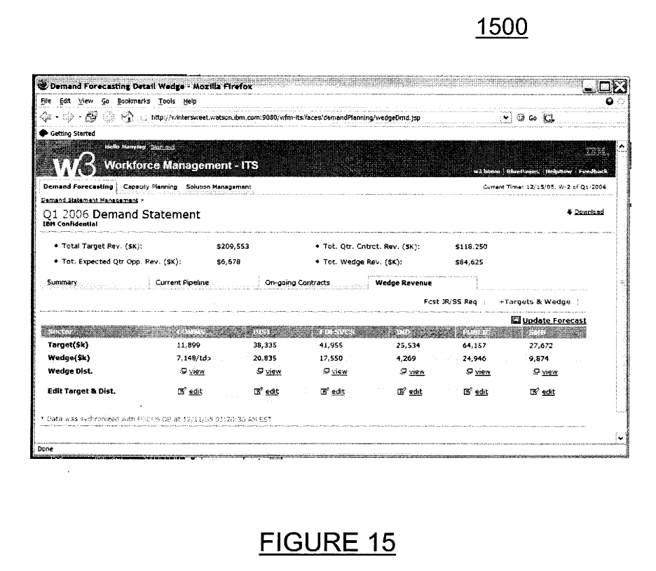

FIG. 15 exemplarily shows a view 1500 of a demand statement providing wedge information. Namely, the wedge demand statement consists of all demand that is not reflected in on-going contracts and pipeline opportunities, with one exemplary example having the wedge demand characterize the demand that fills any shortage between the revenue targets and the revenue of ongoing contracts and pipeline opportunities. This view displays information regarding revenue targets and wedge distribution, supports actions such as modifying revenue targets and adjusting wedge distributions by authorized users.

The Capacity Planning Component

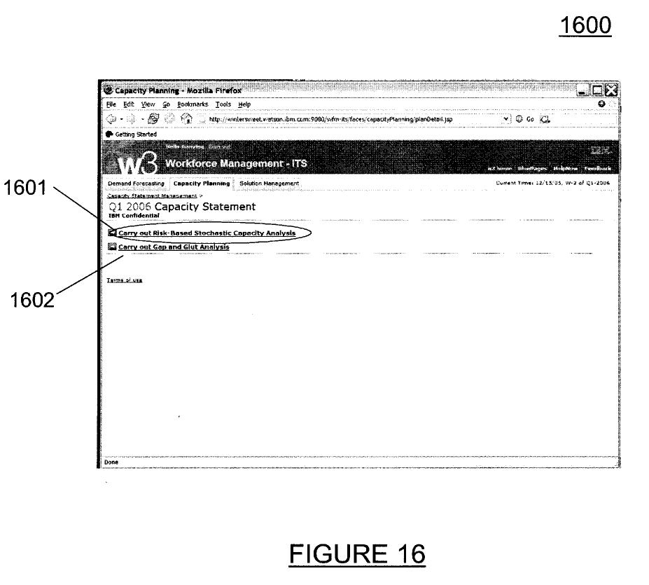

FIGS. 16-25 show details on the capacity planning aspects of the workforce method of the present invention. FIG. 16 shows the interface initial view page 1600 for this feature, providing the user the capability to select either a risk-based stochastic capacity analysis 1601 or gap and glut analysis 1602.

As demonstrated by FIG. 16, the capacity planning interface 1600 of the present invention provides the means and methods for including the capacity planning capabilities within the entire end-to-end methodology and the interactions among the capacity planning capabilities and the other capabilities of the end-to-end methodology, including a link to risk-based stochastic capacity planning and to compute optimal staffing plans and analyze different staffing solutions.

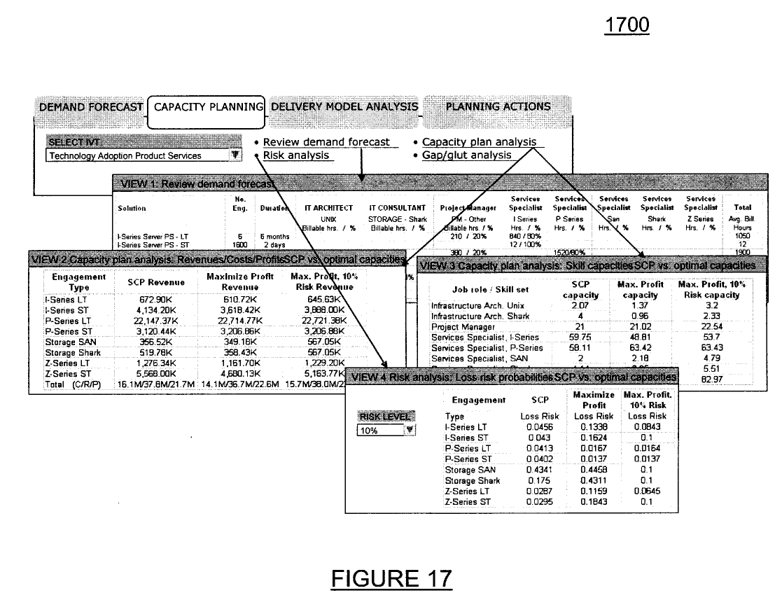

FIG. 17 shows four exemplary web views 1700 that support planning, delivery, interlock, analytics, and decision making throughout the entire workforce management process.

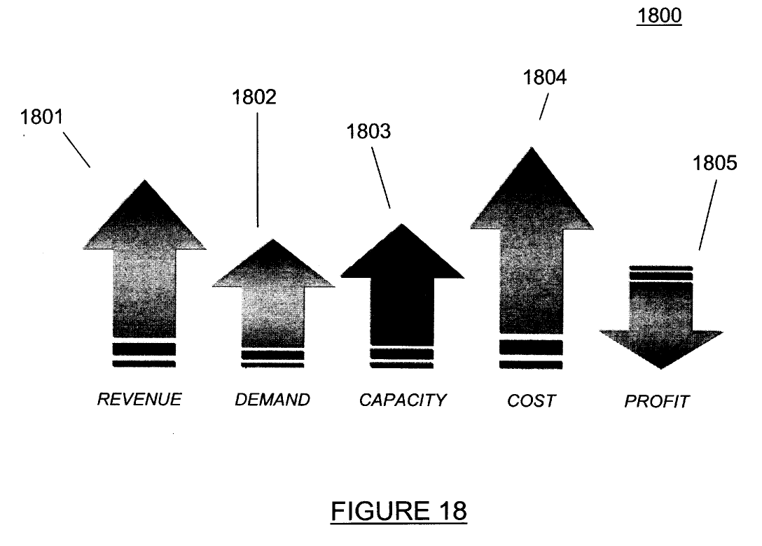

FIG. 18 is intended to demonstrate how the capacity planning component of the end-to-end methodology provides an important lever to determine the operating point for the business. This problem is very complex and involves tradeoffs among revenues 1801, demand 1802, capacity 1803, costs 1804, profits 1805, various business risks, etc. As a simple illustrative example, not intended to limit the scope of the patent in any way, it is noted that, given a forecast of demand, the capacity levels (targets) chosen for each type of skill/experience includes a risk of some projects or services being lost due to the uncertainty of the demand, which in turn can result in a risk of lost revenue for those lost projects or services.

Increasing the capacity levels (targets) for each type of skill/experience can reduce the risk of lost projects or services, and, in turn, the corresponding lost revenue, but this increases the costs of the business. Conversely, decreasing the capacity levels (targets) for each type of skill/experience will reduce the costs of the business, but this can increase the risk of lost projects or services and the revenue at risk of being lost. The expected profit consists of the expected revenue (discounted in an appropriate manner by the revenue at risk) minus the expected costs.

The complex tradeoffs among revenues, costs, profits, demand, capacity, various business risks, etc., involve the complex interactions between the variability and correlation in demand for resource capabilities, skills and experience and in supply for available resources with these capabilities, skills, and experience. This further involves the complex interactions between the variability and correlation in demand and supply over multiple consecutive time periods. The present invention models these complex interactions and tradeoffs using probabilistic methods and optimization methods.

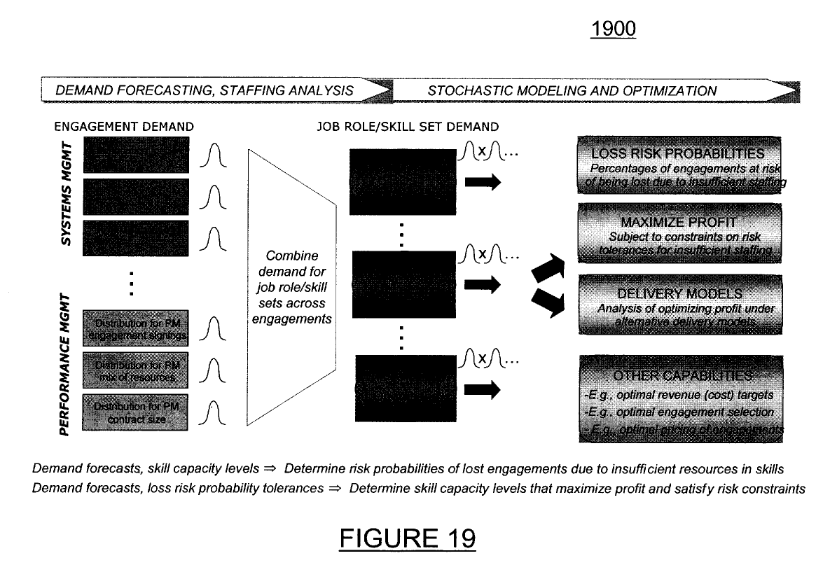

FIG. 19 demonstrates the risk-based stochastic optimization approach to capacity planning of the present invention. Some key aspects of this approach are disclosed in the second of the two above-identified co-pending applications, the contents of which is incorporated herein by reference. This method provides one non-limiting means used in an exemplary embodiment of the present invention with respect to this aspect.

However, other methods to implement this component are also contemplated. As a simple, non-limiting example, one can used the risk-based stochastic optimization approach to determine the optimal way of spending hiring, retraining, etc. budgets to address gaps and gluts in the current workforce, including the possibility of feedback with the multi-skill assignment and gap/glut analysis. Related examples include any set of one or more decision actions involved in capacity planning.

It is also noted that implementation of the present invention may provide some extensions and refinements of the method discussed in the second co-pending application. These extensions are merely due to implementing the method discussed therein into the tool of the present invention and are not intended as limiting or otherwise affecting the scope or details of the method described in this earlier application.

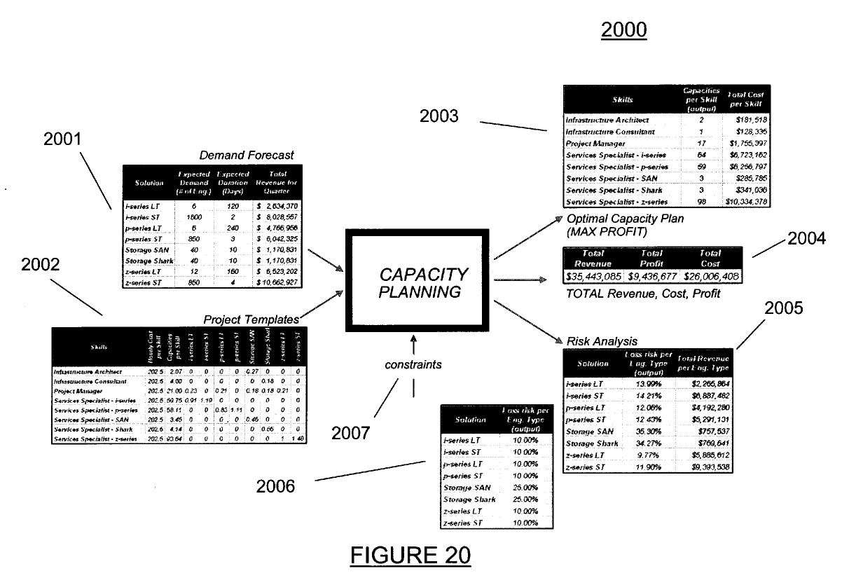

As shown in FIG. 20, the inputs to the capacity planning module 2000 include two parts. First is the demand forecast 2001, in the form of expected number of engagement, expected duration and total revenue for each class of engagements. Second is the project templates 2002, which describe the skill requirements of each engagement class. The capacity planning module 2000, in this case, an optimization engine based upon a stochastic loss network model, will produce an optimal capacity plan 2003, which indicates the skill capacity needed for maximum average profit can be achieved under current forecast, as well as the performance metrics under the planning, which includes costs 2003, 2004, revenues 2004, and risks 2005.

The risk analysis capability, which produces the probability of losing engagement due to insufficient capacities, gives the planner (end user) an option to alter the planning process. Since the emphasis of profit alone might put some of engagement classes under very high risk of losing engagement.

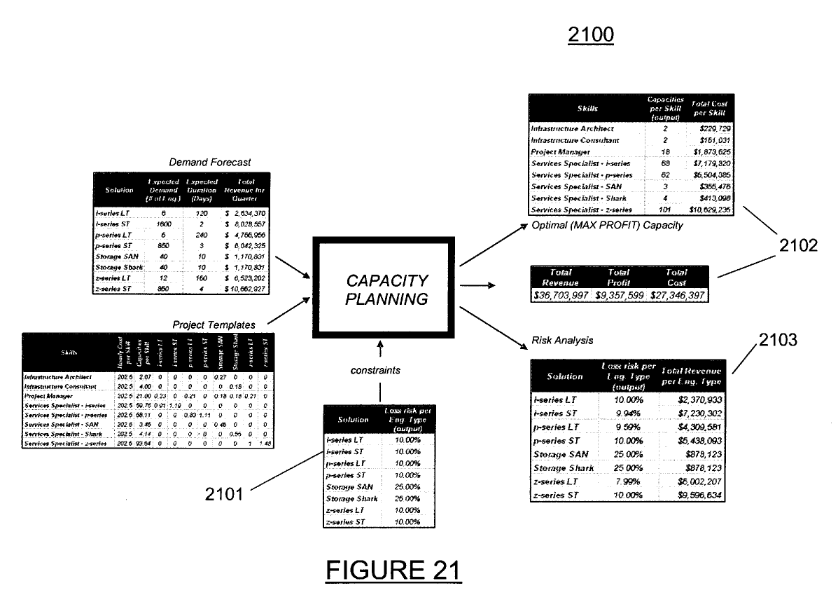

Here, in the example shown in FIG. 20, there are several class engagements 2005 which are exposed to very high risks. The end-user can provide a set 2006 of desired risk limits for each class of engagements, as shown in the example. The capacity planning module then will take them as constraints 2007 to the original optimization engine, and recalculate the optimal capacity 2003,2004,2005 under these constraints, as is shown in FIG. 21, wherein the desired risk limits 2101 have been entered as constraints to provide new optimal capacity 2102 having more desirable risks 2103.

More specifically, the simple illustrative example, not intended to limit the scope of the patent in any way, provided by the above animation, is as follows. The demand forecast and project staffing templates are provided as inputs to the capacity planning component of the end-to-end methodology. The capacity planning optimization determines the staffing levels (targets) for each of the skills in the project templates that maximize profits without any constraints on the loss risk probabilities for each type of engagement.

Alternatively, the staffing levels that maximize revenue or minimize costs, possibly subject to constraints on other financial measures, can equally be determined by the capacity planning optimization. In any case, the capacity planning capability also provides the profits, revenues and costs associated with the optimal staffing level solution. The capacity planning capability also provides the loss risk probabilities for each type of engagement associated with the optimal staffing level solution.

In this simple illustrative example, consider the situation in which the loss risk probabilities are considered too high for the best operation of the business. Then the user can provide tolerances for the loss risk probabilities for each type of engagement and input these into the capacity planning component as constraints on the optimization.

The capacity planning optimization is performed again with the demand forecast, project templates and new loss risk probability constraints to determine the corresponding staffing levels (targets) for each of the skills in the project templates that maximize profits or revenues or that minimize costs. The capacity planning capability again provides the profits, revenues, and costs associated with this optimal staffing level solution, and also provides the loss risk probabilities for each type of engagement associated with the optimal staffing level solution. The user can continue in this fashion until the desired capacity planning solution is obtained.

Comparing these two sets of optimal capacities shown in FIGS. 20 and 21, in the first run (FIG. 20), when profit maximization is the solely consideration, maximum average total profit, in this case is about $9.436 M. However, in doing so, some of the engagements have risks 2005 reaching the neighborhood of 35%. In the second run (FIG. 21), it can be seen that, for the new set optimal capacities, profit decreases slightly, to $9.357 M, but risks 2103 for all the engagement have been tamed.

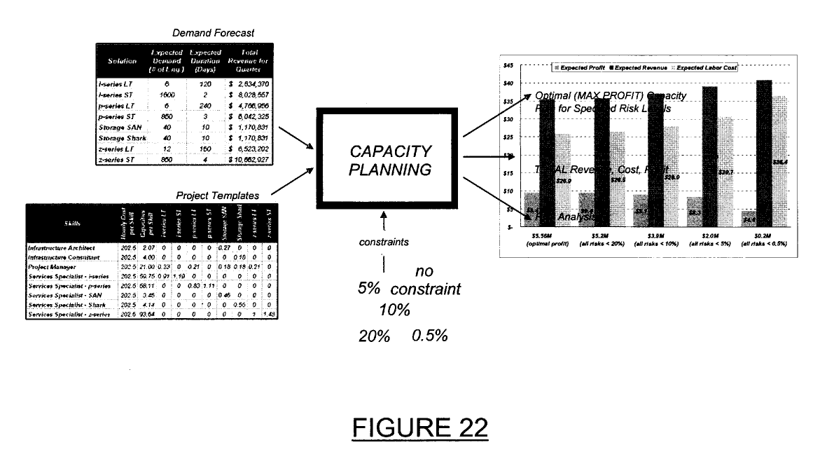

Furthermore, the module can solve a sequence of these profit maximization problems under different risk constraints, and provide visualization of the changes of the performance metrics, such as profit, cost, etc., with respect to the risk constraints. In the simple illustrative example shown in FIG. 22, one can show the performance under 0.5%, 5%, 10%, . . . , 20% and no constraints, and it can be seen that, as the risk constraints becomes tighter, the revenue grows, since less engagement loss is allowed. Meanwhile, the labor cost will increase faster, hence, resulting in the decrease of the profit. This capability to play with constraints will enable a user to have a better understanding of the geometry of the problem space he/she is working on, hence, make better decisions based upon what-if type of analysis.

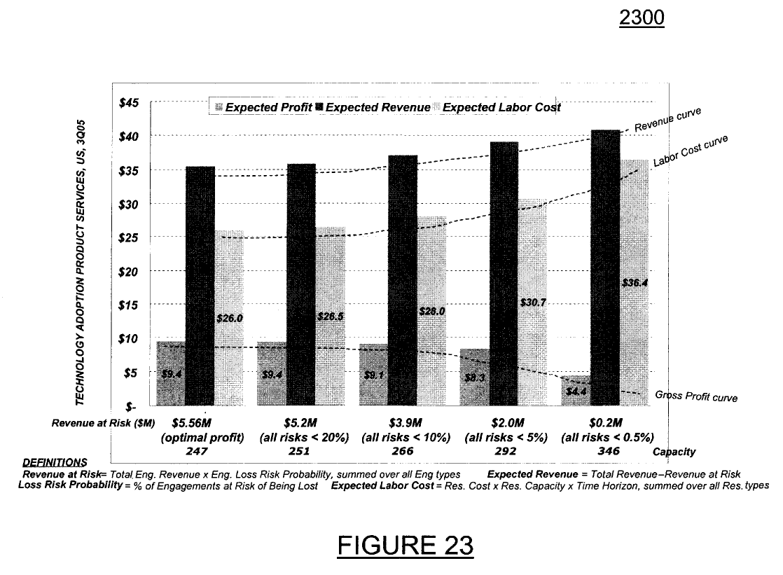

FIG. 23 is a two-dimensional projection of the eight-by-eight solution space for the last simple illustrative example, obtained with the risk-based capacity planning capability. The x-axis is based on the revenue at risk, where moving from left to right one decreases the revenue at risk. Also provided on the x-axis is the total staffing capacities associated with each solution. The y-axis is in terms of millions of dollars.

Considering the left-most collection of histograms 2401, this represents the profits ($9.4), revenues ($35.4) and costs ($26.0) from the risk-based optimal solution with no constraints. Thus, this solution provides the maximum profits, but it also provides the largest revenue at risk ($5.56) and the smallest total staffing capacities (247) among all other optimal solutions.

Moving to the right on the x-axis, it can be seen that, by imposing stricter and stricter loss risk probability constraints, the optimal solutions from the risk-based capacity planning capability tend to increase revenue (because less engagements are at risk of being lost) and increase costs (because of the larger total staffing capacities in order to reduce the loss risk probabilities).

However, following the trend lines it can also be seen that the labor cost curve increases more rapidly than the revenue curve as one moves to the right, and this in turn causes the gross profit curve to decrease as one moves to the right.

More specifically, the second collection of histograms (from the left) represents the profits ($9.4), revenues ($35.8) and costs ($26.5) from the risk-based optimal solution with a loss risk probability constraint of 20% for all engagement types. This solution provides somewhat less profits than optimal, but it also provides somewhat smaller revenue at risk ($5.2) and somewhat larger total staffing capacities (251).

The next collection of histograms to the right represents the profits ($9.1), revenues ($37.1) and costs ($28) from the risk-based optimal solution with a loss risk probability constraint of 10% for all engagement types. This solution provides even less profits than the optimal profit, but it also provides even smaller revenue at risk ($3.9) and even larger total staffing capacities (251).

The next collection of histograms to the right represents the profits ($8.3), revenues ($39) and costs ($30.7) from the risk-based optimal solution with a loss risk probability constraint of 5% for all engagement types. This solution provides even less profits than the optimal profit, but it also provides even smaller revenue at risk ($2.0) and even larger total staffing capacities (292).

The next collection of histograms to the right represents the profits ($4.4), revenues ($40.8) and costs ($36.4) from the risk-based optimal solution with a loss risk probability constraint of 0.5% for all engagement types. This solution provides much less profits than the optimal profit, but it also provides much smaller revenue at risk ($0.2) and much larger total staffing capacities (346).

It is emphasized that each of the solutions described above is an optimal solution obtained from the risk-based capacity planning capability, and, in particular, sub-optimal solutions with the same total staffing capacity levels would be worse with respect to profit, revenue, cost, revenue at risk, etc. Moreover, different loss risk probability constraints can be provided for different types of engagements, as opposed to using a single risk constraint for all engagement types.

Again, although FIG. 23 is a two-dimensional projection of the eight-by-eight solution space obtained with the risk-based capacity planning capability of the present invention, more generally, the risk-based capacity planning capability can provide a full-dimensional space of the multi-dimensional solution of any such capacity planning problem, which can be used to determine the best solution point for a business based on a combination of expected revenues/costs/profits, allowed risk tolerances with respect to revenue loss, and other business concerns, such as market-share and growth.

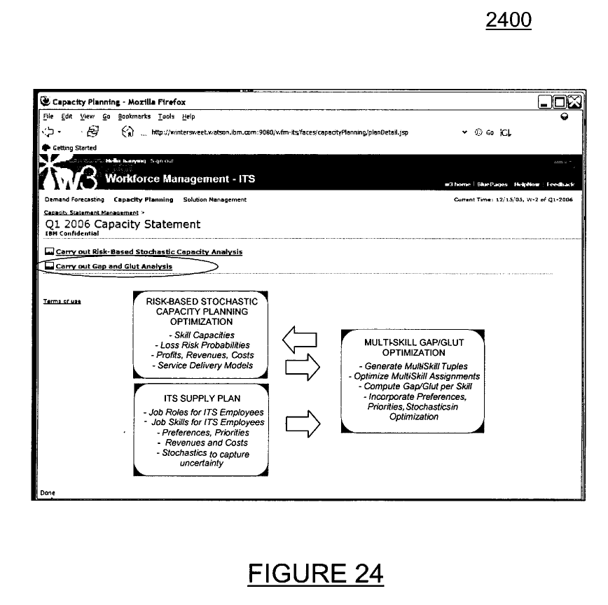

FIG. 24 show exemplarily the interrelations 2400 involved an analysis for gap and glut, as entered into by selecting the gap and glut analysis menu 2401. This feature of the present invention performs skill assignments with priorities/preferences at the planning level and computes gaps and gluts in skill levels over time on a periodic basis.

A multi-skill risk-based stochastic optimization approach to skill assignment and gap/glut analysis of the present invention is further discussed in the second of the two above-identified co-pending applications. It is noted that this approach is only one possible method of implementing the capacity planning component and that alternative expedients for the present invention could be used. As a simple, non-limiting example, one can used the risk-based stochastic optimization approach to determine the optimal way of spending hiring, retraining, etc. budgets to address gaps and gluts in the current workforce. Related examples include any set of one or more decision action involved in skill assignment.

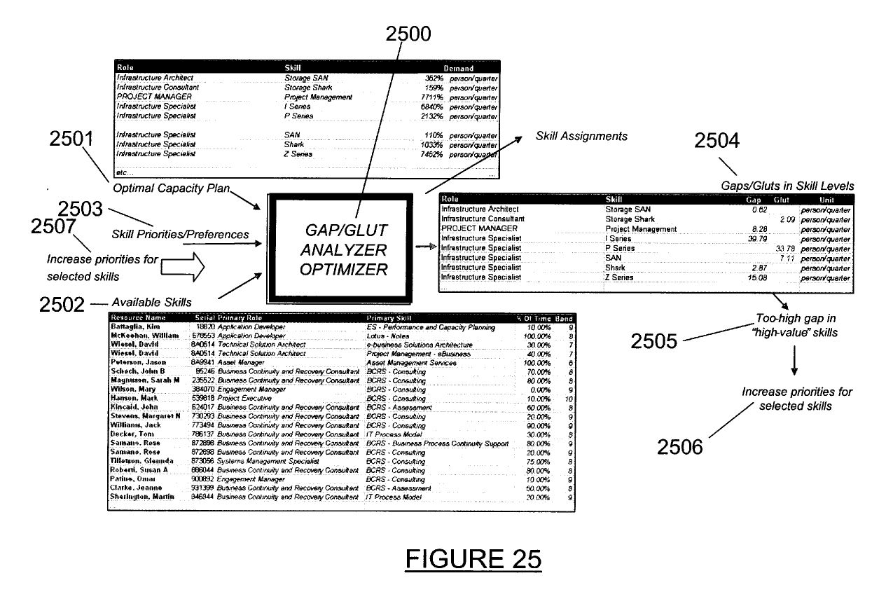

Given the capacity level calculated by the capacity planning module and the Supply portfolio produced by the supply plan module, the multi-skill assignment and gap/glut optimization module 2500 can provide optimal match between them under different weights that are determined by financial considerations or other means (e.g., priorities and preferences), and gap and glut on each skill set under the optimal matching, as exemplarily demonstrated in FIG. 25.

As demonstrated in this figure, an objective of the multi-skill assignment and gap/glut optimization includes individual weights for the gaps and the gluts for each skill, where the weights can reflect measure of financial losses and gains, business losses and gains, project or service quality, business effectiveness, business efficiency, innovation, business opportunities, priorities, preferences, and so on.

In the simple illustrative example shown here, not intended to limit the scope of the patent in any way, the Gap/Glut analytic module 2500, which is a mathematical programming solving engine, takes the optimal capacity plan 2501, which is the output of the capacity planning module, and the available skills input 2502, which consists of the skill possessed, time available and cost index, to produce an optimal skill assignment according to a pre-specified weights on gaps and gluts 2503.

These weights are associated with financial and operational metrics of the skills, such as the cost of acquiring such skill, the potential of the skill in company's long term plans, the criticality of the skill, etc. The Gap/Glut analytic module 2500 allows the end-user to adjust these weights according to their business needs.

For example, in the charts, it can be seen that the initial result 2504 shows that there are some very large gaps in some “high-value” skills 2505, the end-user then can increase the weights on these skills 2506, which reflects different priorities between the skills, hence lower these gaps.

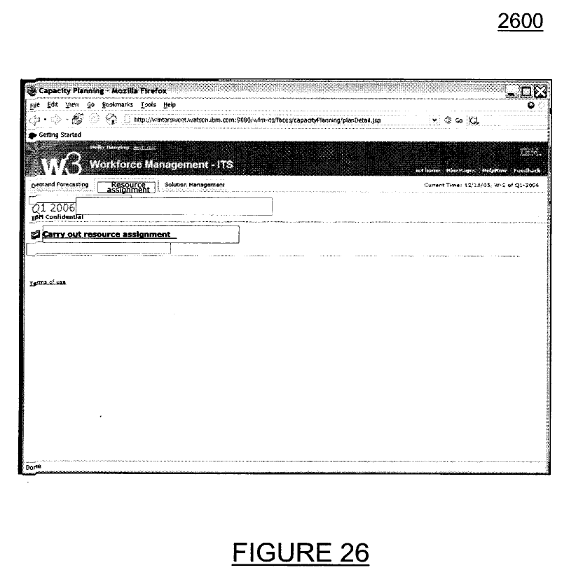

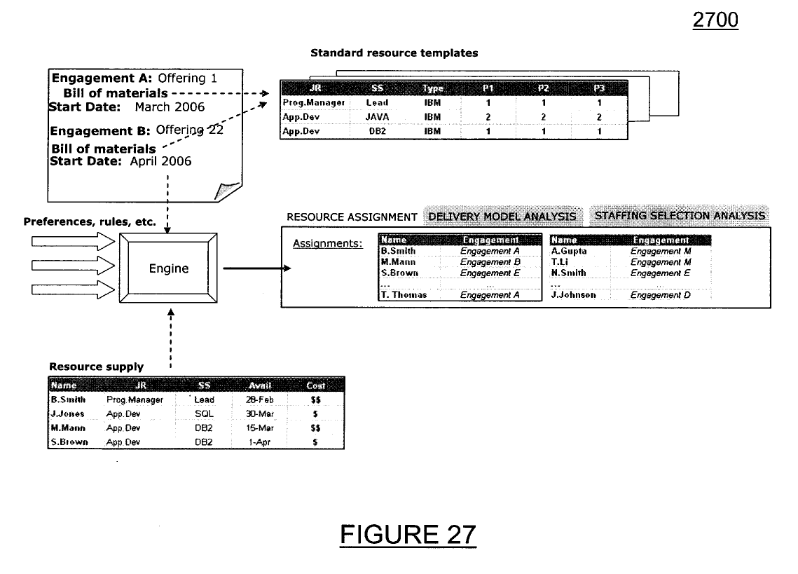

The resource assignment interface 2600 is demonstrated in FIGS. 26 and 27. This feature provides the capability to assign individuals to opportunities, while taking into account business rules for staffing and preferences. FIG. 27 shows multiple web views to support planning, delivery, deployment, interlock, analytics and decision making throughout the entire workforce management process.

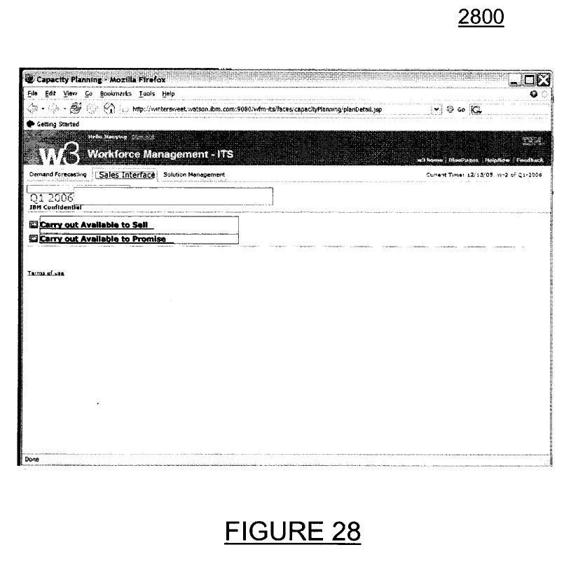

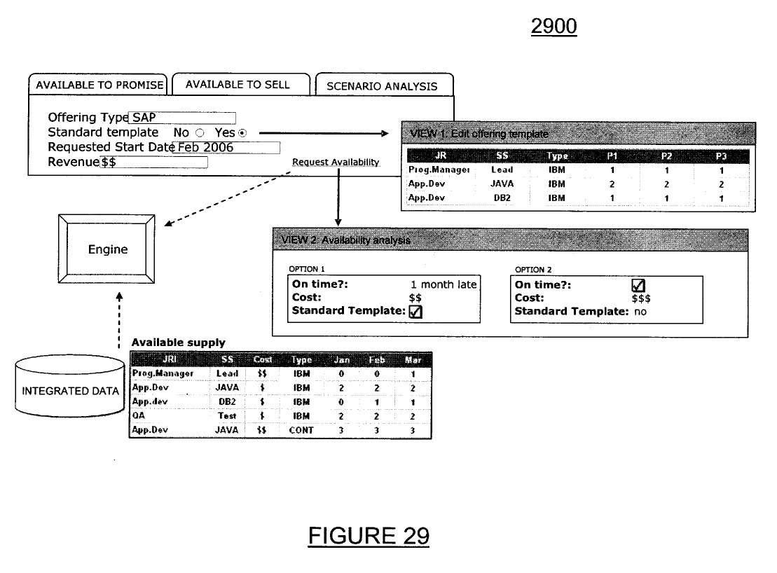

The available to promise/available to sell interface 2800 is shown in FIG. 28. FIG. 29 shows exemplarily two views 2900 available for the available to promise feature.

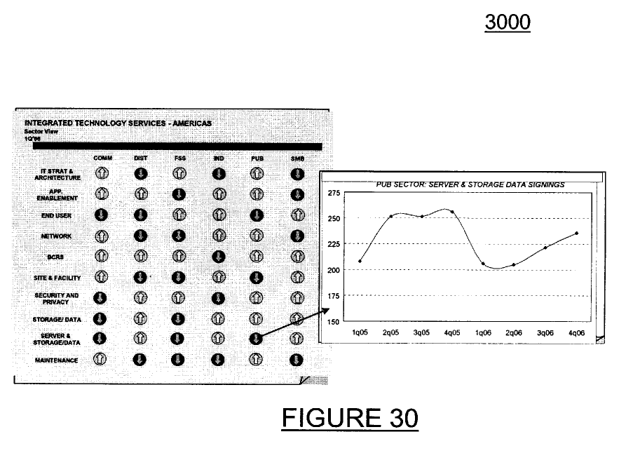

FIG. 30 demonstrates how reporting and visualization capabilities can also be important components of the end-to-end workforce management methodology of the present invention, particularly for executive levels and for high-level planning. Examples of the reporting/visualization capabilities include: Revenue realization/trends in the solution portfolio; Relationship between planned and realized revenue by sector/solution; Relationship between planned and actual staffing; Correlation between staffing and project quality.

Along this line, means and methods of the present invention also provide support for additional capabilities as part of the end-to-end workforce management methodology in order to maximize revenue/profit subject to skill availability, market share data, market demand for offerings, opportunity/pipeline information (current and historical), market demand for skills, etc. Some non-limiting examples include: Price driven demand analysis and pricing targets; and Engagement selection and control.

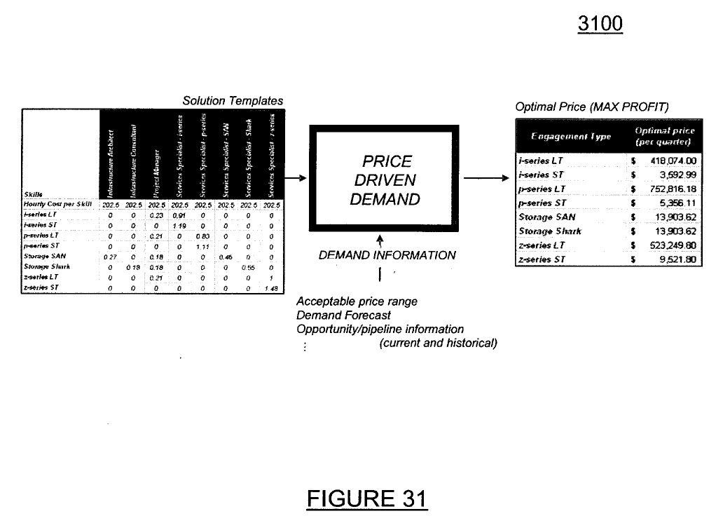

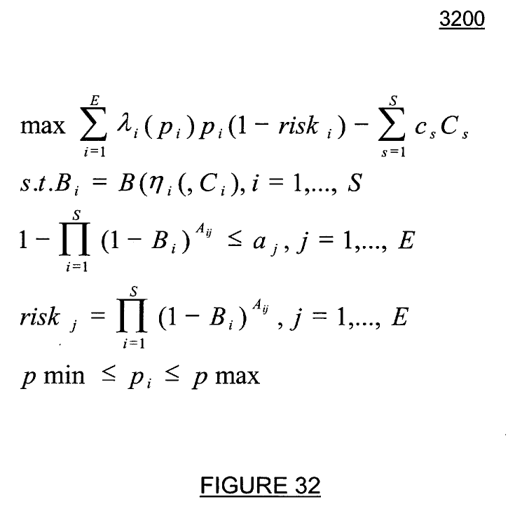

FIGS. 31 and 32 relate to the demand analysis component of the present invention in which risk-based stochastic optimization can be used to determine the “optimal” pricing for offerings, based on revenues, costs, profits, market potential, etc., as exemplarily demonstrated in the price driven demand analysis 3100 shown in FIG. 31.

One way to manage an incoming revenue is through setting the right offering prices. It is well known that the arrival process of different engagement types is strongly dependent on the price a company sets for demanded offerings. In particular, it is usually the case that the higher the price, the lower the demand. Knowing this dependency, available skills, solution templates, opportunity information, risk tolerances, market potential, etc., the risk-based optimization determines the best solution of the problem of maximizing average revenue/profit by setting the right price for each offering.

In particular, given a forecasted demand that provides information about various types of uncertainties and correlations, solution templates for all offerings, resource (human) costs, and relationship between the price that is set for particular offering and induced engagement arrival processes, one can estimate the price for each engagement/solution type that maximizes average profit/revenue over a planning horizon. As additional constraint to the previous optimization, one can set a maximum risk level, in order to control the loss rate of less profitable engagements (offerings). For certain classes of engagement arrival functions, it can be shown that optimization described above yields unique solutions, i.e., price per each offering.

A risk-based stochastic optimization approach that can be used to implement the price driven demand analysis and pricing targets of the present invention is discussed in more detail in the second of the two above-identified co-pending applications, incorporated herein by reference. FIG. 32 provides a simple illustrative example 3200 of risk-based stochastic optimization for price driven demand analysis and optimal pricing targets. The methods of the present invention can be used to solve this optimization problem, and a standard solver can be used to compute the values of this optimal solution.

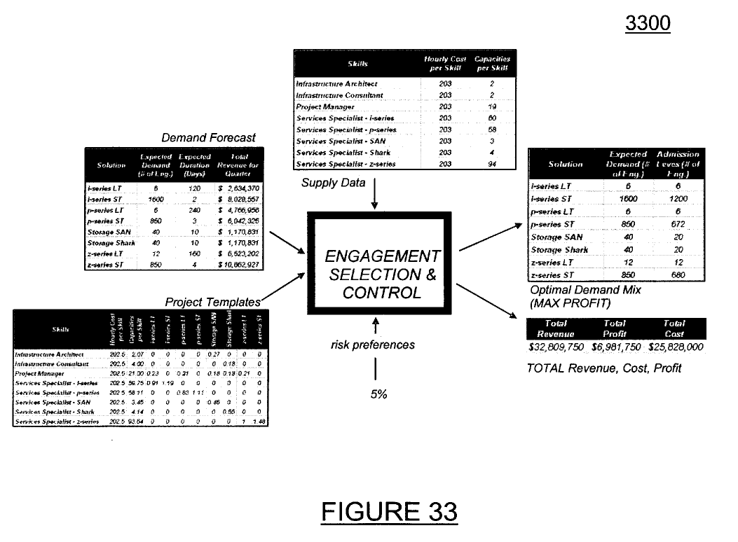

Similarly, as shown in FIG. 33, the risk-based stochastic optimization described in the second co-pending application can also be used to implement the engagement selection and control component 3300 of the present invention.

As exemplarily demonstrated in FIG. 33, a risk-based approach can be used for engagement selection and control that captures various sources and types of uncertainty and their interactions. Planning of the collected revenue in this regard is through a careful engagement selection, assuming that the price per revenue is fixed. Then, subject to available skill capacities, their costs, solution templates, risk tolerances, etc., one can determine what is the proportion of each engagement/offering type that should be accepted in order to maximize revenue/profit and exactly the methods for enacting this proportion of engagement/offering selection.

The present invention uses probabilistic methods and optimization to solve these problems under various sources of uncertainty and the inclusion of setting or constraining risk preferences. For example, for those less profitable engagements a company might decide to be even more selective in order to reduce the chance of rejecting them due to insufficient resources.

In particular, given a forecasted demand that provides information about various types of uncertainties and correlations, solution templates for all offerings, resource (human) costs, and revenues collected for each engagement/solution type, one can estimate what is the optimal proportion of a total number of arrivals for each engagement type that leads to a maximum achieved average collected profit/revenue over a planning horizon. There could be an option of setting a risk tolerance to a particular level, which would eliminate the possibility of having a large proportion of losses for less profitable engagements. This additional constraint would in general increase a total collected revenue, increase number of (human) resources and, therefore, decrease a total collected profit.

### Exemplary Hardware Implementation

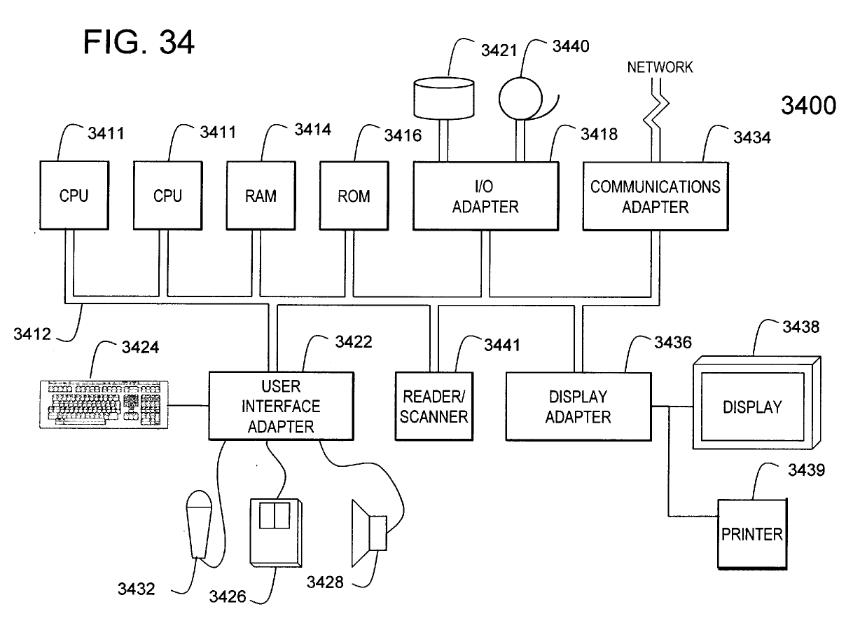

Turning now to the aspect of hardware to implement the present invention, FIG. 34 illustrates a typical hardware configuration of an information handling/computer system in accordance with the invention and which preferably has at least one processor or central processing unit (CPU) 3411.

The CPUs 3411 are interconnected via a system bus 3412 to a random access memory (RAM) 3414, read-only memory (ROM) 3416, input/output (I/O) adapter 3418 (for connecting peripheral devices such as disk units 3421 and tape drives 3440 to the bus 3412), user interface adapter 3422 (for connecting a keyboard 3424, mouse 3426, speaker 3428, microphone 3432, and/or other user interface device to the bus 3412), a communication adapter 3434 for connecting an information handling system to a data processing network, the Internet, an Intranet, a personal area network (PAN), etc., and a display adapter 3436 for connecting the bus 3412 to a display device 3438 and/or printer 3439 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 3411 and hardware above, to perform the method of the invention.

This signal-bearing media may include, for example, a RAM contained within the CPU 3411, as represented by the fast-access storage for example. Alternatively, the instructions may be contained in another signal-bearing media, such as a magnetic data storage diskette 3600 (FIG. 36), directly or indirectly accessible by the CPU 3411.

Whether contained in the diskette 3500, the computer/CPU 3411, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A workforce management tool, comprising:
an input section that receives data from one or more data sources that together reflect data of substantially an entirety of a workforce of an organization; and
a plurality of service modules that receive and process said data in accordance with requirements of different segments of said organization, said plurality of service modules interconnected so that a user in a segment of said organization can selectively view any data of said workforce tool that is related to said segment.

2. The workforce management tool of claim 1, wherein at least one of said service modules can optimize local objectives of said segment such that said local objectives are consistent with optimal global objectives of said organization.

3. The tool of claim 1, wherein said data into said input section of said tool is received from a unified repository of data which, in turn, receives data from said one or more data sources.

4. The tool of claim 3, further comprising one or more input stages for said unified repository of data, said one or more input stages performing one or more of:
extracting data automatically from said one or more data sources;
validating data received from said one or more data sources before forwarding it into the unified repository of data; and
transforming data received from said one or more data sources before forwarding it into the unified repository of data.

5. The tool of claim 1, wherein said user in said segment selectively views said data related to said user's segment by way of selecting one or more presentation views of said data, said presentation views designed to present data for use by said segment within said organization.

6. The tool of claim 5, wherein said views of said data and said service modules are based upon a plurality of components that comprise said organization.

7. The method of claim 6, said plurality of components comprising one or more of:
a demand component related to demands of said workforce;
a supply component related to available resources and skills of said workforce;
a capacity planning component that includes one or more of uncertainty factors, business objectives, and risk preferences; and
a decision support component.

8. The tool of claim 2, wherein said optimization function is achieved by a risk-based stochastic approach.

9. The tool of claim 2, wherein said optimization function is achieved by converting data from said data sources into a nonlinear programming problem and solving said nonlinear programming problem.

10. The tool of claim 1, further comprising:
a user interface section that permits said user to interact with said tool, said user interface comprising a plurality of presentation views oriented to at least one of a position, status, and function of said user within said organization, and said presentation views provide said user a limited access and control of said tool.

11. The tool of claim 2, wherein said different segments of said organization are predetermined as comprising key stakeholders in a process of said organization that uses said workforce, and said plurality of service modules are interconnected in a topology so that information is exchanged to allow global and local objectives to be concurrently optimized.

12. The tool of claim 1, wherein said tool comprises a multi-tier architecture that allows said tool to be readily expandable for at least one of data sources, service modules, and user interfaces.

13. The tool of claim 5, wherein one or more presentation views provide information for normal operations of an organization using said workforce.

14. The tool of claim 1, wherein said service modules provide outputs based on a planning cycle of said organization and outputs of said planning cycle can be used as inputs into a subsequent planning cycle.

15. A signal-bearing medium tangibly embodying a program of machine-readable instructions executable by a digital processing apparatus to perform as a component of the tool of claim 1.

16. A method of operating an organization, said method comprising:
providing a workforce management tool, said tool comprising an input section that receives data from one or more data sources that together reflect data of substantially an entirety of a workforce of the organization and a plurality of service modules that receive and process said data in accordance with requirements of different segments of said organization, said plurality of service modules interconnected such that a user in a segment of said organization can selectively access all data in said one or more data sources that is related to said segment; and
obtaining information from said workforce management tool.

17. The method of claim 16, wherein said workforce management tool is located on one of
a computer local to the organization; and
a computer remote from the organization and accessible to said organization by another organization providing a service to said organization that is related to said workforce management tool.

18. The method of claim 16, wherein said tool is stored at a location remote from said organization that uses said information from said tool for said managing, said organization accesses said tool by one of:
downloading said tool from said remote location and using said tool locally; and
downloading one or more components of said tool and using said tool locally.

19. A method of developing an end-to-end workforce management scheme in an organization, said method comprising:
determining processes of said organization;
determining data sources related to said processes, said data sources providing data for substantially an entirety of a workforce of said organization; and
designing and implementing one or more service modules to receive data from said data sources to allow a user in one of said processes to selectively access all data related to that process.

20. The method of claim 19, further comprising:
designing an optimization function in at least one said service module, said optimization function permitting optimization of local objectives for said processes that are consistent with optimal global objectives of said organization.
